(19) United States
(12) Patent Application Publication
(10) Pub. No.: US 2002/0159189 A1
(43) Pub. Date: Oct. 31, 2002

(54) Controlling eject distance of a disk cartridge from a disk drive

(76) Inventors: Lawrence Clayton, Farmington, UT (US); Michael Paul Nelson, Kaysville, UT (US)

Correspondence Address: Woodcock Washburn Kurtz, Mackiewicz & Norris LLP, 46th Floor, One Liberty Place, Philadelphia, PA, 19103, US

(21) Appl. No.: 09/841,718

(22) Filed: Apr. 25, 2001

(51) Int. Cl. G11B 17/04

(52) U.S. Cl. 360/99.06

(57) ABSTRACT

A drive receives a removable storage cartridge thereinto and retains the received cartridge. The cartridge includes a shell and a storage media disposed within the shell. The drive has a motor for engaging the media within the retained cartridge and applying a motive force to the engaged media, and an ejection mechanism for ejecting the retained cartridge upon actuation. The drive also has a stopper for contacting the cartridge at least during ejection thereof and for co-acting with the ejecting cartridge to stop the ejecting cartridge at a predetermined ejection travel distance. The cartridge has a stop feature that co-acts with the stopper.

### FIELD OF THE INVENTION

The present invention relates to a disk drive for receiving a disk disposed within an inserted cartridge and a device that controls the distance that the cartridge is ejected from the disk drive. More particularly, the present invention relates to such a disk drive having a catching device that catches the ejected disk cartridge after the cartridge has traveled a predetermined distance along an eject path.

### BACKGROUND OF THE INVENTION

A disk drive for receiving a removable disk cartridge is known. Examples of a disk drive include a conventional 3.5 inch ‘floppy’ disk drive, a “ZIP” disk drive as developed and marketed by IOMEGA Corporation of Roy, Utah, and the like. Such a disk drive is typically coupled to a processor or the like, and facilitates an exchange of information between the processor and a disk contained within the disk cartridge. The disk and the disk drive may be magnetically or optically based, for example.

The disk cartridge typically includes an outer casing or shell that houses the aforementioned disk therein. The disk is mounted on a hub and can rotate freely within the cartridge, and the hub of the disk is externally accessible by way of an access aperture defined in one of the planar panels of the cartridge. Typically, the disk drive includes a frame or chassis and a disk motor which is mounted thereto, wherein during operation of the drive, the motor engages the hub of the disk through the cartridge access aperture and applies a rotating force to such hub.

In one arrangement, the disk cartridge is inserted into, retained within, and ejected from the disk drive generally within an X-Y plane, and the motor is moved into contact with the retained disk in a direction generally perpendicular to the X-Y plane of such inserted disk, i.e., along a Z-axis. Such movement of such motor may be actuated as part of receiving and retaining the disk cartridge in the frame, and may for example be achieved by helically mounting the motor within the frame, by positioning the motor on a bi-level slide, or by pivoting the motor along an appropriate axis. Accordingly, the motor is moved relative to the disk along the Z-axis between a disk-engagement or loaded position and a disk-separation or unloaded position.

In at least some disk drives, the frame includes laterally arranged tracks on either side thereof for receiving corresponding lateral edges of the disk cartridge during cartridge insertion. Thus, the tracks guide the cartridge into the drive during insertion, hold the cartridge during retention, and guide the cartridge out of the drive during ejection. As may be appreciated, such tracks in the frame generally align with a cartridge opening in the disk drive, and the cartridge passes through the aligned opening during insertion and ejection thereof.

Typically, the ejection mechanism for a disk drive is mechanically based or electrically based. In the mechanical case, a mechanical eject button is externally positioned on the disk drive, where the mechanical button is the distal end of an ejection link that extends within the drive to a ejection mechanism, and physical pressure is applied to such mechanical button and transferred to the ejection mechanism by way of the ejection link to mechanically effectuate ejection of an inserted disk cartridge. In the electrical case, an electrical eject button may be externally positioned on the disk drive, where the electrical button electrically actuates an ejection mechanism within the disk drive, and the ejection mechanism as actuated effectuates ejection of an inserted disk cartridge. Note that in addition to or instead of the electrical button, electrical actuation of the ejection mechanism may occur by way of a signal received from the processor to which the disk drive is coupled. At any rate, ejection of a disk cartridge, be it mechanically or electrically based, is generally known or should be apparent to the relevant public and therefore need not be discussed herein in any detail.

The distance that the disk cartridge travels during ejection from the disk drive is important to the proper function of the drive. If the cartridge eject distance is too small, the cartridge may not protrude through the cartridge opening far enough to be grasped and pulled out. If the eject distance is too large, the cartridge may completely exit the drive and fall or even be projected some distance. Due to the nature of the ejection mechanism in a disk drive, be it mechanically or electrically based, there are many variables and tolerances which affect the eject distance of the cartridge. In short, cartridge eject distance of a disk drive is subject to a relatively wide range in variation, and is relatively difficult to control within an acceptable range.

Accordingly, a need exists for a device in a disk drive that controls the cartridge eject distance to be within a relatively narrow acceptable range in a relatively simple and economical manner.

### SUMMARY OF THE INVENTION

The present invention satisfies the aforementioned need by providing a disk drive for receiving a removable storage disk cartridge thereinto and retaining the received cartridge. The cartridge includes a shell and a storage media disposed within the shell. The drive has a motor for engaging the media within the retained cartridge and applying a motive force to the engaged media, and an ejection mechanism for ejecting the retained cartridge upon actuation. The drive also has a stopper for contacting the cartridge at least during ejection thereof and for co-acting with the ejecting cartridge to stop the ejecting cartridge at a predetermined ejection travel distance. The cartridge has a stop feature that co-acts with the stopper.

### BRIEF DESCRIPTION OF THE DRAWINGS

The foregoing summary as well as the following detailed description of the present invention will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a perspective view of the interior of a disk drive in accordance with one embodiment of the present invention;

FIG. 2 is a perspective view of a disk cartridge for being received into the disk drive of FIG. 1, and a catch device for being mounted to the disk drive of claim 1 in accordance with one embodiment of the present invention;

FIG. 3 is another perspective view of the disk cartridge of FIG. 2, and shows a catch feature for being caught by the catch device of FIG. 2 in accordance with one embodiment of the present invention; and

FIG. 4 is an enlarged view of the catch feature shown in FIG. 3.

### DETAILED DESCRIPTION OF THE PREFERRED EMBODIMENT

Certain terminology may be used in the following description for convenience only and is not considered to be limiting. For example, the words “left”, “right”, “upper”, and “lower” designate directions in the drawings to which reference is made. Likewise, the words “inwardly” and “outwardly” are directions toward and away from, respectively, the geometric center of the referenced object. The terminology includes the words above specifically mentioned, derivatives thereof, and words of similar import.

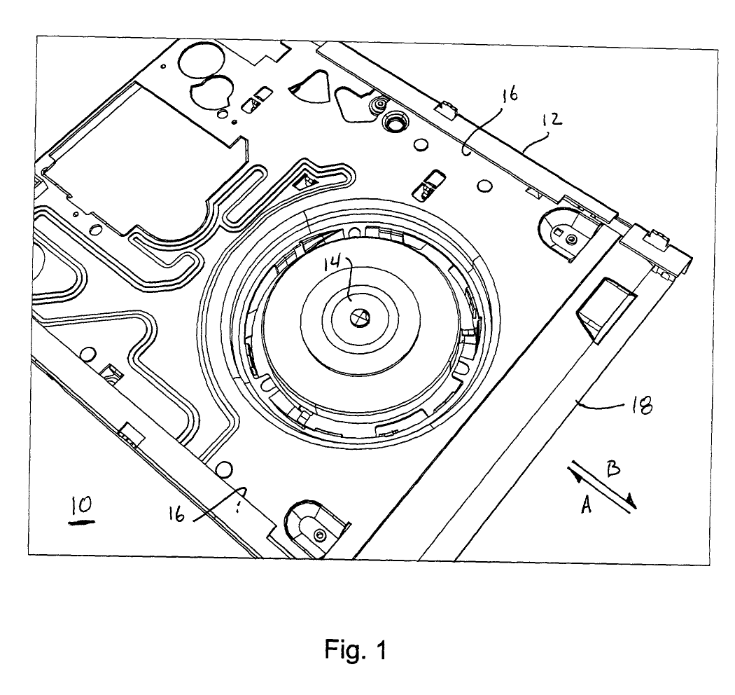

Referring now to FIG. 1, there is shown a disk drive 10 in accordance with one embodiment of the present invention. As was discussed above, the disk drive 10 is for receiving a removable disk (not shown) such as a conventional 3.5 inch ‘floppy’ disk or a “ZIP” disk as developed and marketed by IOMEGA Corporation of Roy, Utah, and the like. The disk may be mounted on a generally coaxial hub (not shown) or may define a generally coaxial aperture (not shown) at the center thereof. As was discussed above, the disk is positioned within a cartridge 13 that includes an outer casing or shell 15. The disk can rotate freely within the cartridge 13, and the hub or aperture of the disk is externally accessible by way of an access aperture (not shown) defined in an appropriate one of the planar panels of the shell 15 of the cartridge 13. Of course, the disk drive 10 may be for receiving any type of disk, magnetic, optical, or otherwise, with or without a hub, without departing from the spirit and scope of the present invention.

The disk drive 10 includes a frame or chassis 12 and a disk motor 14 which is mounted thereto, wherein during operation of the drive 10, the motor 14 engages the disk at the hub or aperture thereof by way of the access aperture of the cartridge 13 and applies a rotating force thereto. The disk cartridge 13 and disk therein are inserted into (arrow A, FIGS. 1-3), retained within, and ejected from (arrow B, FIGS. 1-3) the drive 10 generally within an X-Y plane that is generally parallel to and within the general extent of the frame 12 of the drive 10, and the motor 14 is moved relative to the disk cartridge and disk into a loaded position and into contact with the disk generally along a Z-axis generally perpendicular to the X-Y plane. Upon ejection of the disk cartridge and disk therein, the motor 14 is moved relative to the disk cartridge and disk back out to an unloaded position and out of contact with the disk along the Z-axis.

In one embodiment of the present invention, and as best seen in FIG. 1, the frame 12 includes laterally arranged tracks 16 on either side thereof for receiving and guiding corresponding lateral edges 17 of the disk cartridge 13 during insertion, retention, and ejection of the cartridge 13. As seen, such tracks 16 in the frame 12 generally align with a cartridge opening 18 in the disk drive 10, and the cartridge 13 with the disk therein passes through the aligned opening 18 during insertion and ejection thereof.

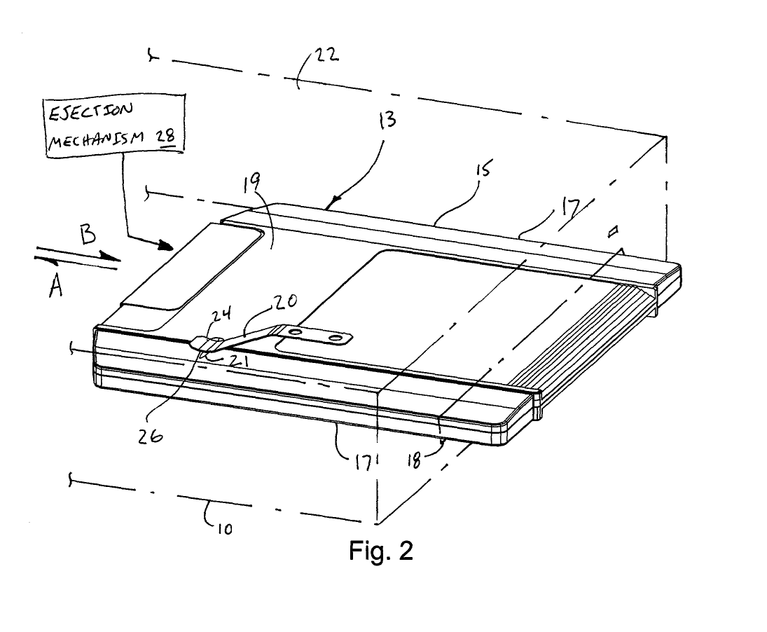

As was discussed above, and as seen in FIG. 2, the disk drive 10 includes an electrical or mechanical ejection mechanism 28 that ejects the retained cartridge 13 upon actuation. Again, ejection of a disk cartridge 13, be it mechanically or electrically based, is generally known or should be apparent to the relevant public and therefore need not be discussed herein in any detail. Accordingly, any appropriate ejection mechanism 28 may be employed without departing from the spirit and scope of the present invention.

In one embodiment of the present invention, to control the distance that the disk cartridge 13 travels during ejection from the disk drive 10, the disk drive 10 is provided with a stopper 20 (FIG. 2) that contacts the cartridge 13 at least during ejection and that co-acts with the cartridge 13 to stop the cartridge 13 at a predetermined ejection travel distance. In one embodiment of the present invention, and as shown in FIG. 2, the stopper 20 is a bias spring mounted on the drive 10. However, the stopper 20 may be any appropriate device without departing from the spirit and scope of the present invention as long as the stopper 20 performs the functions associated therewith as disclosed herein.

In one embodiment of the present invention, and as seen in FIG. 2, the disk drive 10 has a top wall 22 generally parallel to the retained disk cartridge 13 and on a side of the disk cartridge 13 opposite the motor 14, and the stopper 20 is mounted to an inner side of the top wall 22 and extends down toward and into the path that the disk cartridge 13 travels during ejection. Thus, and as seen, a distal end 24 of the stopper 20 contacts a top surface 19 of the disk cartridge 13 as the disk cartridge 13 travels along the ejection path, and such contact by the stopper 20 halts the traveling disk cartridge at the aforementioned predetermined ejection travel distance.

Note that in the embodiment shown in FIG. 2, the bias spring stopper 20 as mounted to the inner side of the top wall 22 extends down toward and exerts a downward pressure on the disk cartridge 13 even as the disk cartridge 13 is retained within the disk drive 10. Thus, the stopper 20 also acts to hold the retained cartridge 13 down against the motor 14.

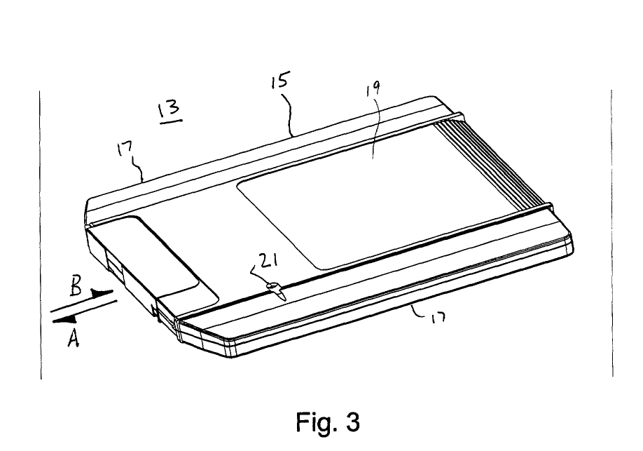

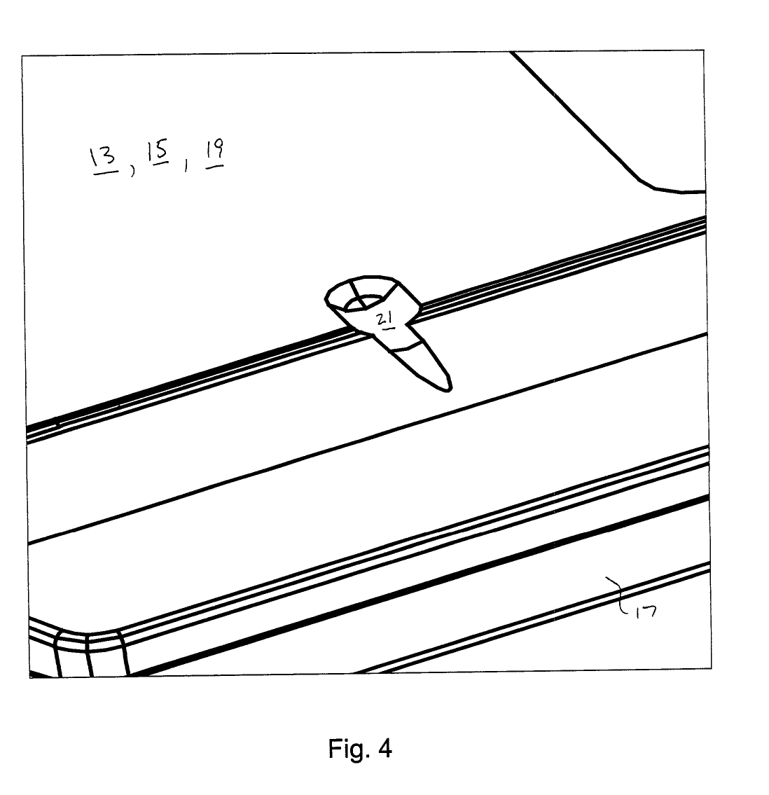

In one embodiment of the present invention, the stopper 20 positively co-acts with the cartridge 13 during ejection thereof to stop the cartridge 13 at the predetermined ejection travel distance, as is seen in FIG. 2. In particular, and as seen in FIGS. 3 and 4, the disk cartridge 13 at the top surface 19 thereof is provided with a stop feature 21 that is contacted by the distal end 24 of the stopper 20 as the disk cartridge 13 is being ejected. Importantly, when such contact occurs, further travel of the disk cartridge 13 along the ejection travel path is halted. Thus, such stopper 20 and stop feature 21 in combination define the predetermined ejection travel distance. Appropriate positioning of both the stopper 20 within the disk drive 10 and the stop feature 21 on the top surface 19 of the disk cartridge 13 to achieve the contact therebetween at the predetermined ejection travel distance should by now be appreciated by the relevant public and therefore need not be described herein in any detail.

In one embodiment of the present invention, the stop feature 21 on the top surface 19 of the disk cartridge 13 is a recess, as shown. Thus, contact with the stopper 20 comprises the distal end 24 thereof springing down and into the recess. Alternatively, the stop feature 21 may be a bump or a rough surface on the top surface 19 of the cartridge 13, in which case the distal end 24 of the stopper 20 would spring up or frictionally co-act with the stop feature 21, respectively.

In any case, the distal end 24 of the stopper 20 preferably comprises a contacting surface 26 that glides along the top surface 19 of the traveling cartridge 13 in areas away from the stop feature 21, and that positively co-acts with the stop feature 21 to stop the ejecting cartridge 13 at the predetermined ejection travel distance. Also in any case, the distal end 24 of the stopper 20 and the contacting surface 26 thereof preferably do not interfere with grasping of the stopped cartridge 13 by a user or the like and continued removal of the disk cartridge 13 from the disk drive 10 through the cartridge opening 18 thereof. For example, and as seen, the contacting surface may comprise a generally convex curvature that generally is matched to the generally concave recess stop feature 21. Such generally convex curvature also is amenable to the stop feature 21 in cases where such stop feature 21 is a bump or a rough surface.

In the foregoing description, it can be seen that the present invention comprises a new and useful stopper 20 in a disk drive that controls the cartridge eject distance to be within a relatively narrow acceptable range in a relatively simple and economical manner. It should be appreciated that changes could be made to the embodiments described above without departing from the inventive concepts thereof. For example, the stopper 20 may be located elsewhere, such as for example below or on a side of the retained disk cartridge 13, and the co-acting stop feature 21 may be appropriately positioned based on the location of the stopper 20. Likewise, the cartridge 13 may contain an item other than a disk, such as for example a tape. It should be understood, therefore, that this invention is not limited to the particular embodiments disclosed, but it is intended to cover modifications within the spirit and scope of the present invention as defined by the appended claims.

1. A storage drive for receiving a removable storage media cartridge thereinto and retaining the received cartridge, the cartridge including a shell and a storage media disposed within the shell, the drive comprising:
a motor for engaging the media within the retained cartridge and applying a motive force to the engaged media;
an ejection mechanism for ejecting the retained cartridge upon actuation; and
a stopper for contacting the cartridge at least during ejection thereof and for co-acting with the ejecting cartridge to stop the ejecting cartridge at a predetermined ejection travel distance.

2. The drive of claim 1 comprising a disk drive for receiving a removable storage disk cartridge including a shell and a storage disk disposed within the shell, wherein the motor is a disk motor for engaging the disk within the retained disk cartridge and applying a rotating force to the engaged disk.

3. The drive of claim 1 wherein the stopper is a bias spring mounted to the drive.

4. The drive of claim 1 wherein the drive further comprises a wall generally parallel to the retained cartridge and adjacent a side of the retained cartridge opposite the motor, and wherein the stopper is mounted to an inner side of the wall and extends toward and into a path that the cartridge travels during ejection.

5. The drive of claim 4 wherein the stopper pressures the retained cartridge against the motor.

6. The drive of claim 1 wherein a distal end of the stopper contacts a surface of the cartridge as the cartridge travels along an ejection path, and wherein such contact by the stopper halts the traveling cartridge at the predetermined ejection travel distance.

7. The drive of claim 1 wherein the stopper is for positively co-acting with a stop feature on a surface of the ejecting cartridge to stop the cartridge at the predetermined ejection travel distance, the stop feature being contacted by a distal end of the stopper as the cartridge is being ejected, whereby such contact halts further travel of the ejecting cartridge, and whereby the stopper and stop feature in combination define the predetermined ejection travel distance.

8. The drive of claim 7 wherein the stopper is for positively co-acting with a recess on the surface of the ejecting cartridge to stop the cartridge at the predetermined ejection travel distance.

9. The drive of claim 8 wherein the stopper has a contacting surface with a generally convex curvature at a distal end thereof for positively co-acting with a generally concave recess on the surface of the ejecting cartridge to stop the cartridge at the predetermined ejection travel distance.

10. The drive of claim 1 in combination with the cartridge.

11. A cartridge for being received into a storage drive and retained therein, the cartridge comprising:
a shell;
a storage media disposed within the shell for being engaged by a motor of the drive and for receiving a motive force from the engaging motor; and
a stop feature on a surface of the shell, the stop feature for being contacted by a stopper of the drive upon ejection of the retained cartridge from the drive, the stop feature co-acting with the stopper to stop the ejecting cartridge at a predetermined ejection travel distance.

12. The cartridge of claim 11 wherein the stop feature is a recess on the surface of the cartridge.

13. The cartridge of claim 12 wherein the stop feature is a generally concave recess on the surface of the cartridge.

14. The cartridge of claim 11 comprising a disk cartridge for being received into a disk drive and retained therein, the disk cartridge comprising a storage disk disposed within the shell for being engaged by a disk motor of the drive and for being rotated by the engaging disk motor.

15. The cartridge of claim 11 wherein the stopper is mounted to an inner side of a wall of the drive and adjacent a side of the retained cartridge opposite the motor and extends toward and into a path that the cartridge travels during ejection, and wherein the stop feature is positioned on the side of the retained cartridge opposite the motor to be contacted by the stopper as the cartridge travels the ejection path.

16. The cartridge of claim 11 in combination with the drive.
